(19) United States
(12) Patent Application Publication
(10) Pub. No.: US 2026/0074824 A1
(43) Pub. Date: Mar. 12, 2026

(54) ERROR CORRECTION CODE PROTECTED TRANSCEIVER SYSTEMS AND METHODS

(71) Applicant: Eridu Corporation, Saratoga, CA (US)

(72) Inventors: Ting-Kuang Chiang, Saratoga, CA (US); Drew Perkins, Los Gatos, CA (US)

(73) Assignee: Eridu Corporation, Saratoga, CA (US)

(21) Appl. No.: 19/324,101

(22) Filed: Sep. 9, 2025

Related U.S. Application Data
(60) Provisional application No. 63/692,697, filed on Sep. 9, 2024.

(51) Int. Cl. H04L 1/00; H04B 10/50; H04B 10/516; H04B 10/60

(52) U.S. Cl. CPC H04L 1/0041; H04B 10/503; H04B 10/516; H04B 10/60

(57) ABSTRACT

Consistent with an aspect of the present disclosure, an exemplary digital communication system is provided that includes redundant or spare transceivers to handle failure events. In one example, if one of the first N+r transceivers experience a failure, spatial FEC codewords can correct the resulting bit errors and, as previously mentioned, prevent post-FEC errors from occurring. In embodiments, if a primary transceiver fails, a redundant transceiver may be activated to take its place.

This application claims the benefit of U.S. Provisional Ser. No. 63/692,697 filed on Sep. 9, 2024, the entire contents of which are incorporated herein by reference.

### BACKGROUND

### A. Technical Field

The present disclosure relates generally to digital communication systems and methods. More particularly, the present disclosure relates to systems and methods for correcting bit errors and improving data integrity in high-speed data transmission that enhances data transmission reliability in large volume data transmission systems.

### B. Background

Conventional digital communication systems often face bit errors due to noise and bandwidth limitations. Although Forward Error Correction (FEC) codes can be used to detect and correct these errors, stronger FEC codes increase transmission overhead and are insufficient in handling complete transceiver failures. Additionally, differences in receiver performance and the inherent limitations of FEC codes leave some errors uncorrected. Accordingly, it is desirable to have systems and methods that overcome the limitations of existing methods to enhance data transmission reliability.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures are not drawn to scale.

FIG. 1 depicts a common digital communication system having N transmitters and N receivers.

FIG. 2 depicts a bit error in the digital communication system of FIG. 1.

FIG. 3 depicts FEC check bits added to the payload shown in FIG. 1.

FIG. 4 depicts an exemplary Frame Alignment Signal (FAS) pattern.

FIG. 5a illustrates an example of a forward error correction spatial decoder circuits consistent with an aspect of the present disclosure.

FIG. 5b illustrates an exemplary digital communication system that utilizes spatial forward error correction (FEC) according to various embodiments of the present disclosure.

FIG. 5c shows an example of a transmitter consistent with an aspect of the present disclosure.

FIG. 6a shows an example of FEC encoder circuitry and sparing circuitry (for redundancy) consistent with an additional aspect of the present disclosure.

FIG. 6b illustrates an exemplary digital communication system that utilizes redundant transceivers according to various embodiments of the present disclosure.

FIG. 6c shows an example of FEC decoder circuitry and sparing circuitry (for redundance) consistent with a further aspect of the present disclosure.

FIG. 7a illustrates an example of temporal and spatial FEC encoding circuitry in combination with redundant or sparing circuitry consistent with an additional aspect of the present disclosure.

FIG. 7b illustrates an exemplary digital communication system that utilizes temporal FEC, spatial FEC, and redundant transceivers, according to various embodiments of the present disclosure.

FIG. 7c shows an example of temporal and spatial FEC decoding circuitry in combination with redundant or sparing circuitry consistent with a further aspect of the present disclosure.

FIG. 8 is a flowchart illustrating a process for using spatial FEC according to various embodiments of the present disclosure.

FIG. 9 is a flowchart illustrating a process for using spare transceivers with spatial FEC according to various embodiments of the present disclosure.

FIG. 10 is a flowchart illustrating a process for using spare transceivers with spatial FEC in conjunction with temporal FEC according to various embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion components may be described as separate functional units, which may comprise sub-units, but those skilled in the art will recognize that various components, or portions thereof, may be divided into separate components or may be integrated, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification do not necessarily all refer to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure. The terms “spare” and “redundant” may be used interchangeably; similarly, the terms “primary transmitter” and “lead transmitter” may be used interchangeably.

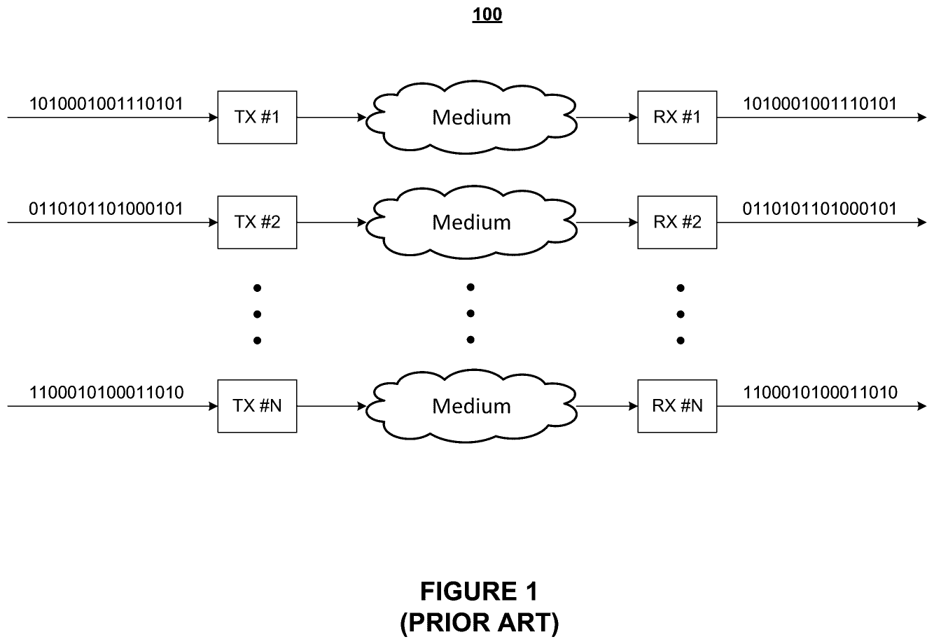

In conventional communication systems, several transceivers, each comprising a transmitter and a receiver, are connected through a medium such as a fiber optic or coaxial transmission lines to form communication links. A typical digital communication system, such as system 100 shown in FIG. 1, can have any number of communication links or channels. As depicted, system 100 comprises N co-located communication links. For simplicity, communication in only one direction is shown in FIG. 1. As a person of skill in the art will appreciate, an exemplary bi-directional communication system may comprise transmitters and receivers on both ends of each link.

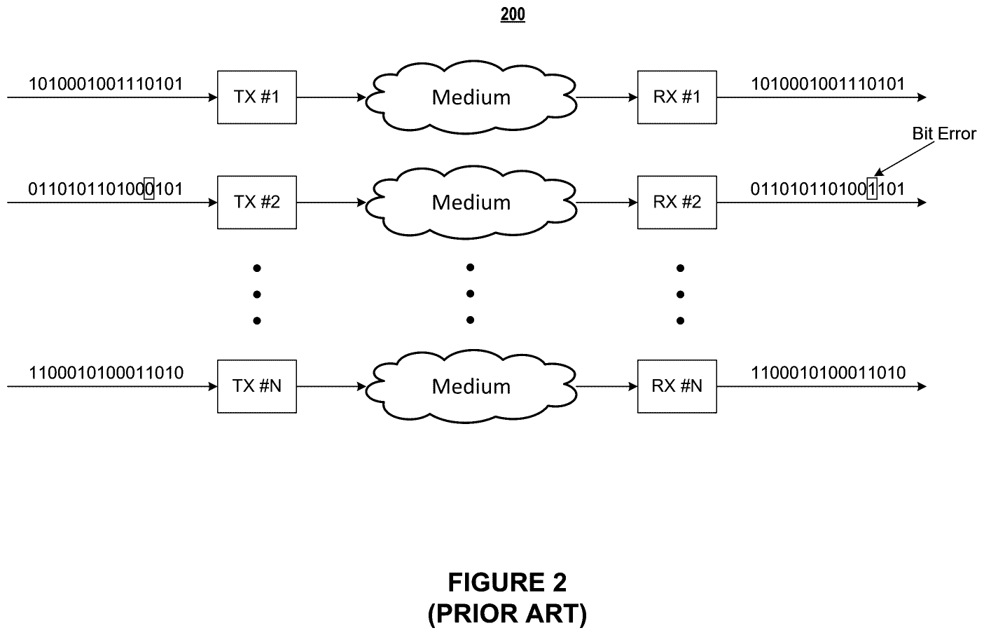

In practice, in applications that require the transmission of vast amounts of data, system 100 typically spreads the data across all communication links, each associated with an individual transceiver, and transmits the data in parallel. As illustrated in FIG. 2, in any such digital communication system, occasionally, the data output by a receiver contains bit errors due to discrepancies between the transmitted and received signals caused by factors like a noisy or lossy transmission channel or bandwidth limitations of the transmitter or receiver.

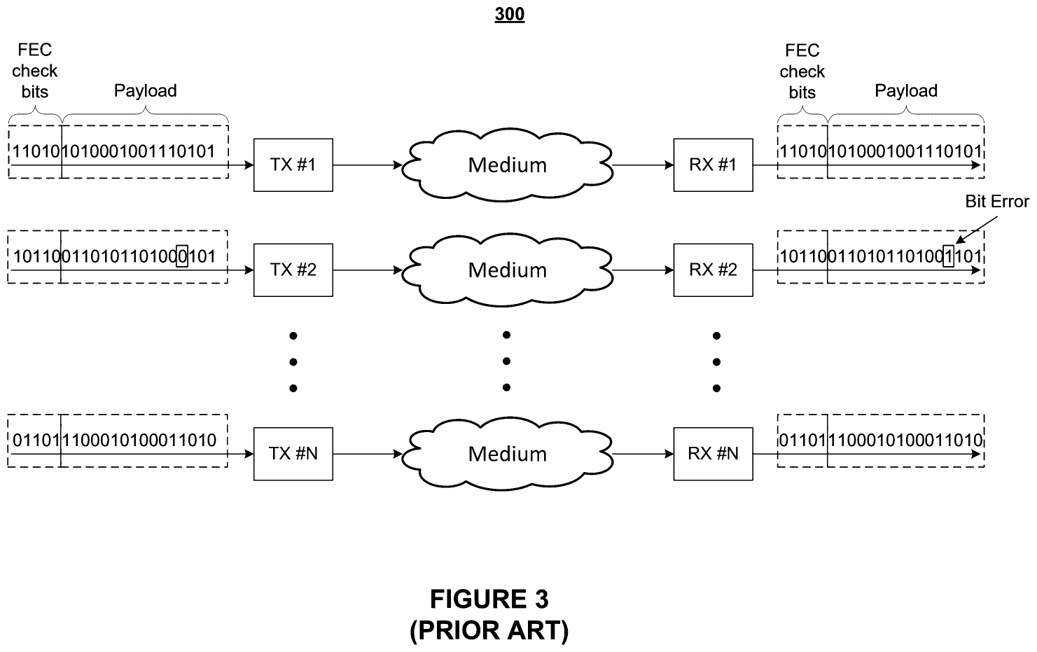

To detect and correct for bit errors, many existing approaches employ Forward Error Correction (FEC) code—a type of Error Correction Code (ECC). FEC, which is primarily used for data transmission in digital communications, involves an FEC code, which is a transmitter algorithm or scheme that generates FEC check bits, i.e., redundant or parity bits. As depicted in FIG. 3, prior to transmission, these FEC check bits are added to the payload (i.e., the transmitted data that comprises information bits). The encoded data, which comprises a combination of the original payload and the added FEC check bits, forms an FEC codeword. At the receiver end, the FEC codeword is decoded, thus allowing the receiver to detect and correct bit errors in the received data.

Since FEC check bits are added to the payload, the total number of transmitted bits increases, thus raising the transmit bit rate. Intuitively, the robustness of the FEC code is directly related to the bit error rate that it is designed to protect against. However, stronger FEC codes provide greater error correction capability at the expense of higher redundancy and increased transmission overhead. For example, if four parity bits are added to each FEC codeword, and each transceiver can only handle a certain number of bits, it may be necessary to use four additional transceivers to accommodate the extra FEC data to ensure that the data can be transmitted without exceeding the capacity of any individual transceiver.

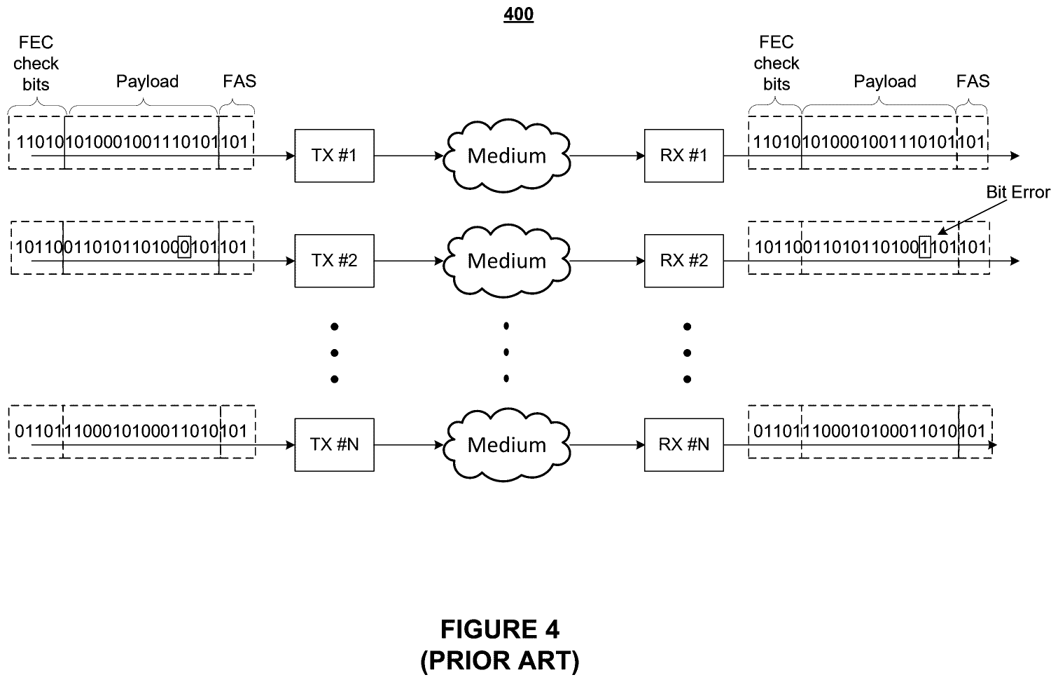

FIG. 4 shows an exemplary Frame Alignment Signal (FAS) pattern. To enable a receiver to identify the beginning of the payload data, the transmitter typically inserts a FAS into the data stream at regular intervals. The FAS is a specific sequence of bits that indicates the beginning of each codeword. When the receiver detects and locks onto the FAS pattern, it can extract the payload data and the associated FEC data, thereby synchronizing with the transmitter to ensure that the data is correctly interpreted and aligned. However, due to inherent differences in the receivers within a system, some receivers are susceptible to higher bit error rates than others. In addition, FEC codes have a limited capability to correct errors in the individual bits of a codeword, i.e., a unit of data that the FEC algorithm processes. For example, a particular FEC code may be able to correct up to three bit errors in a codeword. Therefore, once a codeword contains more errors than a given FEC can correct, post-FEC bit errors will remain uncorrected, and the received data will still contain some errors even after the FEC process.

To address this, a FEC gain sharing scheme is oftentimes used that interleaves multiple FEC-encoded data streams. A common method is bit-wise interleaving (e.g., in a round-robin manner) to sequentially interleave bits from different streams. This approach distributes excess bit errors across several codewords in various data streams, which helps the system tolerate clusters of errors that would otherwise exceed the correction capability of a single codeword. In this manner, by distributing FEC words across a number of transceivers, even if an entire channel fails, bit errors may be corrected without the need for retransmission, which is beneficial for real-time and one-way communication systems. To manage timing differences that can arise from transmitting data across multiple channels, a buffer is often used to deskew the data. This buffer aligns the data from different channels before processing to correctly synchronize the data. Since most FEC schemes can correct single-bit errors, each stream's FEC can successfully correct the distributed errors, enhancing overall error correction capability.

While adding FEC to the data stream helps tolerate high bit error rates, FEC schemes are typically not designed to handle complete transceiver failures. Such failures increase the bit error rate to levels beyond the correction capability of FECs.

FEC gain sharing interleaves some number of FEC codewords from different channels. The errors in the worst performing channel are distributed across many FEC codewords such that they are better tolerated by the FEC code. FEC gain sharing can manage clustered errors but is ineffective against complete transceiver failures, unless a large number of channels are interleaved and a very strong FEC code is used.

As an example, in optical transceiver links, a common cause of complete transceiver failure is a failure of the laser, which causes the entire link to go down. Other system components can also fail, and different types of transceivers can experience complete failures. Accordingly, what is needed are systems and methods for reducing the impact of systemic and random error sources, such as noise and inherent variability in electrical components to improve the efficiency and reliability of modern high-speed, large-volume data transmission systems.

Unlike approaches that add FEC check bits in the time-domain to spread the redundancy over time within a single continuous data stream to correct errors that occur over different time intervals within the same stream, various embodiments herein, add FEC check bits in the spatial domain, such that the redundancy is interleaved across multiple transceivers or data streams. By interleaving FEC words across a number of transceivers, even if an entire channel fails, bit errors are be corrected without the need for retransmission, which is beneficial for real-time and one-way communication systems. In embodiments disclosed herein, this is accomplished by using transmitters that each carries a portion of both the data and the parity bits.

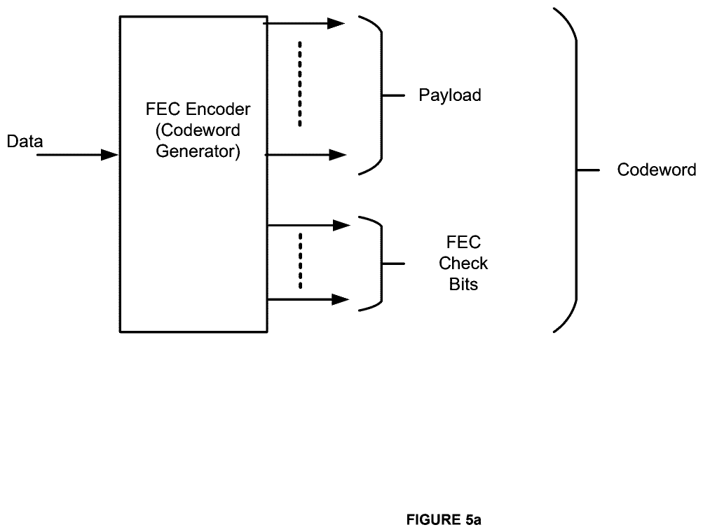

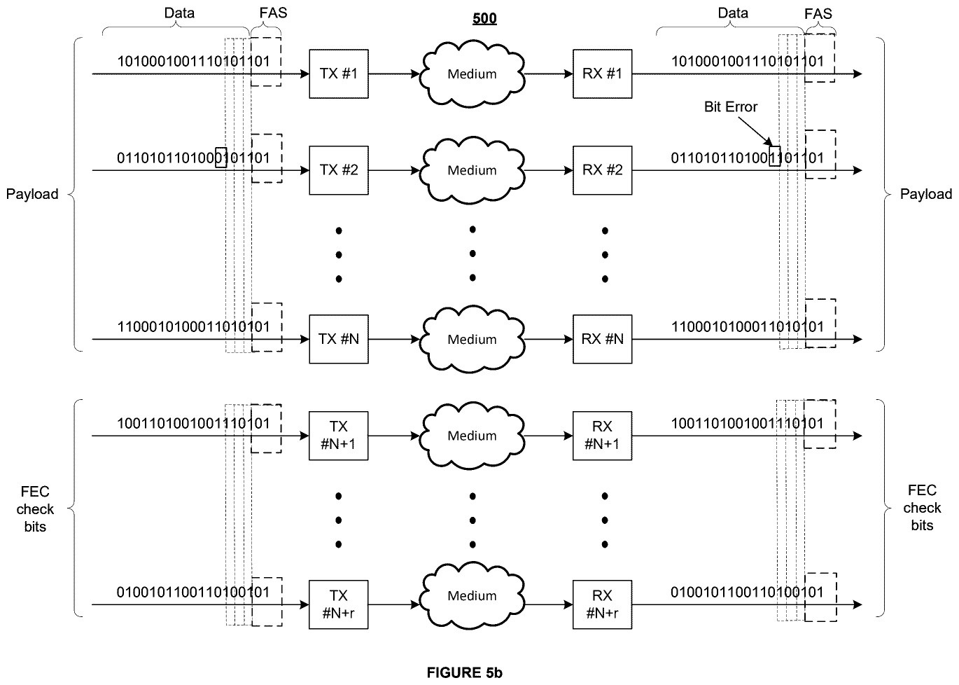

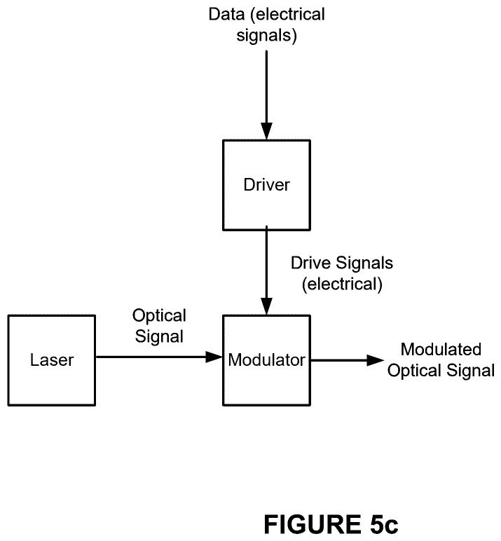

FIG. 5a shows an example of an FEC encoder circuit or codeword generator circuit that receives, in one example, a serial stream of data or data bits. The encoder circuit outputs each bit of the codeword, which includes payload bits and FEC check bits, in parallel, as further shown in FIG. 5a.

FIG. 5b illustrates an exemplary digital communication system using a spatial FEC method and the FEC encoder circuit shown in FIG. 5a, according to various embodiments of the present disclosure. For simplicity, as with FIG. 1 through FIG. 4, only communication in one direction is shown. Digital communication system 500 comprises N+r co-located transceiver links. The vertical dashed lines in FIG. 5 illustrate four vertical slices of codewords, where the first N bits represent the payload portion of each codeword, while the next r bits represent the FEC check bits portion. These codewords are simultaneously transmitted through system 500.

To ensure that receivers can correctly identify and process the data and FEC check bits, a FAS may be used to align the portions of the FEC words that are distributed across a number of transceivers. For example, for 16-bit data 16 transceivers may be used, with each transceiver carrying a portion of the data and the FEC check bits.

Each FEC codeword in FIG. 5b is distributed among many transceiver links. For example, each FEC codeword might have N payload data bits and r FEC check bits. These N+r bits may be distributed among N+r transceiver links, as shown in FIG. 5b. Each transceiver link carries one bit from each FEC codeword. The FEC check bits are generated for the entire payload data, e.g., by a central processor or a designated lead transmitter. These payload bits and FEC check bits are then divided and assigned to each transmitter, with each transmitter responsible for transmitting one bit of each FEC codeword. If the FEC code being used can correct up to m bit errors in each FEC codeword, then the FEC code can support up to m laser failures. The bit errors caused by the laser failure will render the associated received data completely unusable. However, despite the corruption or failure of any individual transceiver, the spatial FEC can use the FEC check bits carried by other properly operating transceivers to correct the errors. Advantageously, using redundancy spread across multiple channels in this manner allows the system to reconstruct the original data and protect against the effects of complete failures of individual transceivers.

In more general cases, each FEC codeword in FIG. 5b may occupy a certain number of bits (1 to k) in each transceiver link. The total number of payload data bits in each FEC codeword is calculated as k*N, and the total number of bits in each FEC codeword is k*(N+r) where the total number of FEC check bits in each FEC codeword is k*r. The FEC check bits are generated for the entire payload data, e.g., by a central processor or a designated lead transmitter. These payload bits and FEC check bits are then divided and assigned to each transmitter, with each transmitter responsible for transmitting k bits of each FEC codeword. If the FEC code being used can correct up to m bit errors in each FEC codeword, then the number of laser failures the FEC code can support is less than or equal to m/k. The bit errors caused by the laser failure will render the associated received data completely unusable. However, despite the corruption or failure of any individual transceiver, the spatial FEC can use the FEC check bits carried by other properly operating transceivers to correct the errors. Advantageously, using redundancy spread across multiple channels in this manner allows the system to reconstruct the original data and protect against the effects of complete failures of individual transceivers.

Alternatively, if each FEC codeword size is k*(N+r) bits with k*N payload bits and k*r FEC check bits, these k*(N+r) bits can be distributed among the N+r transceivers in ways different from what was shown in FIG. 5b as long as the receivers can reassemble the complete FEC codeword. For example, the first N+r bits of the payload bits can be distributed among all N+r transceivers followed by the next N+r payload bits until all k*N payload bits are used. This bit distribution process can continue with the k*r FEC check bits until all k*(N+r) bits in the FEC codeword are distributed among the N+r transceivers.

FIG. 5c shows an example of an optical transmitter consistent with an aspect of the present disclosure. The optical transmitter includes a laser, which may be a semiconductor laser, that supplies a continuous wave (CW) optical signal, for example. In a further example, the optical signal is supplied to a modulator, which may be a Mach-Zehnder modulator. As further shown in FIG. 5c, data or bits carried by an electrical signal is supplied to a driver circuit, which, in turn, supplies drive signals to modulator to thereby modulate the optical signal. As a result, a modulated optical signal is output from the modulator that is indicative of the data input to the driver circuit. It is understood, that the optical transmitters shown in FIGS. 5b, 6b, and 7b may have the same structure as that shown in FIG. 5c.

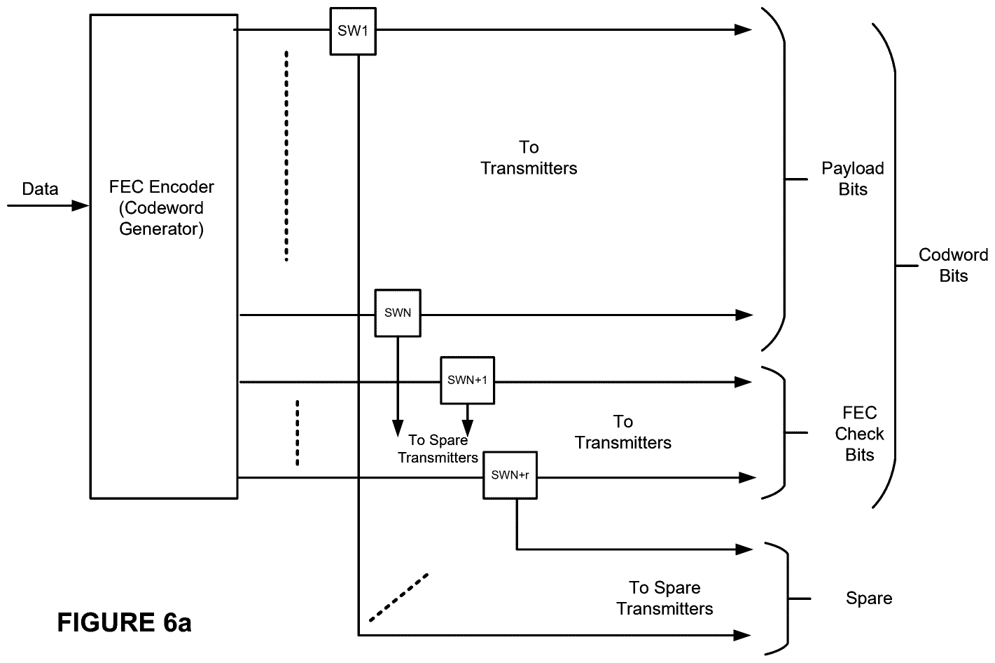

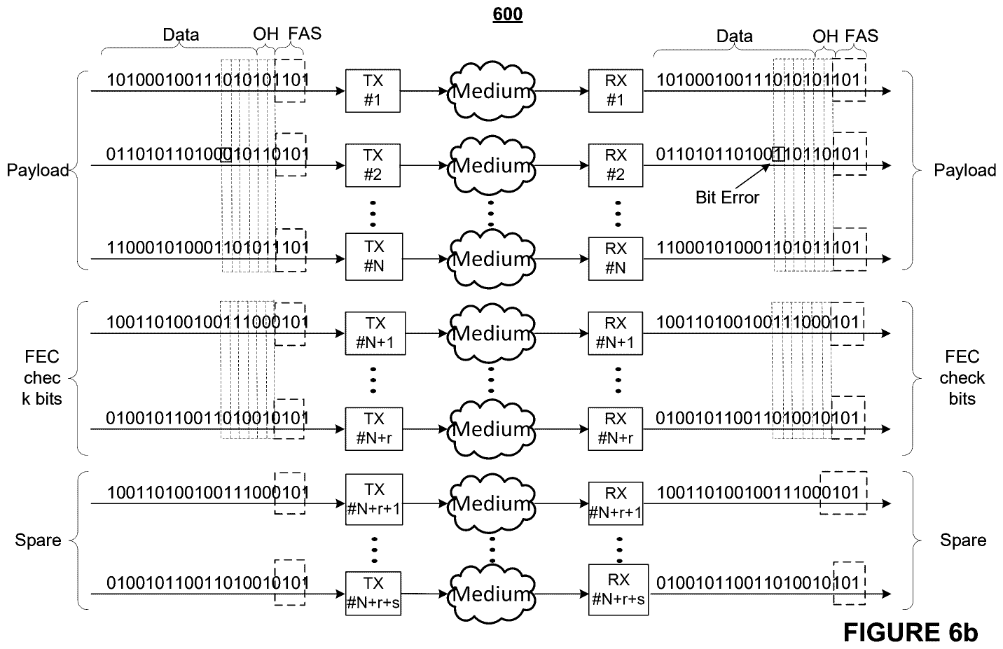

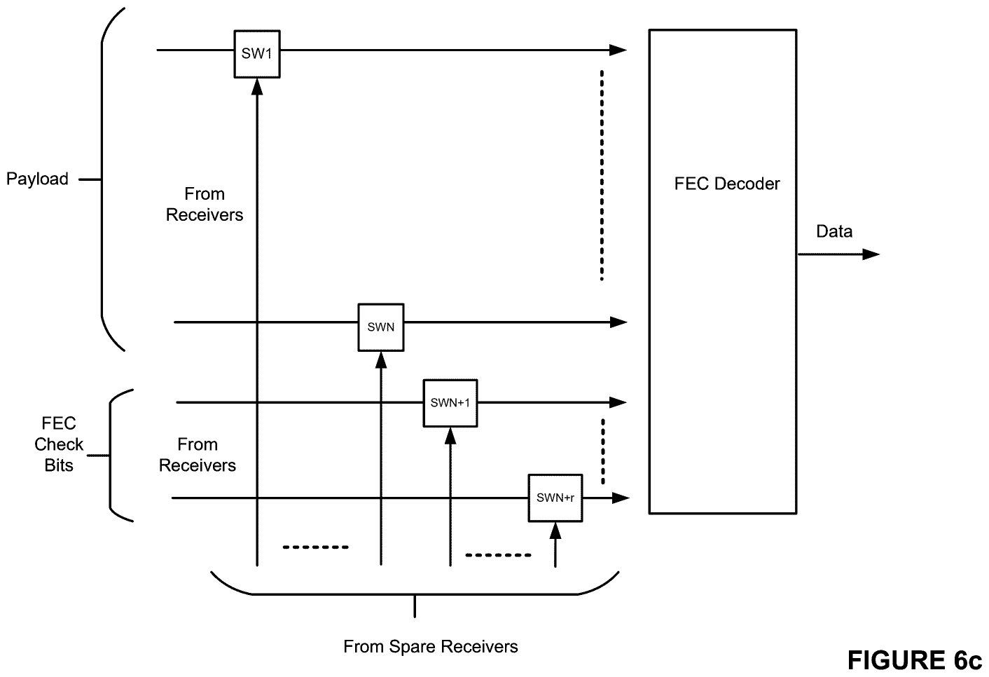

An example of an optical communication system employing spatial FEC and spare or redundance lines or links will next be described with reference to FIGS. 6a to 6c.

FIG. 6a shows a block diagram of FEC encoder circuitry in combination with sparing or redundancy circuitry consistent with an aspect of the present disclosure.

FIG. 6b illustrates an exemplary digital communication system that utilizes redundant transceivers, according to various embodiments of the present disclosure. As depicted, communication system 600 comprises s spare or redundant transceivers. In embodiments, to handle failure events, if one of the first N+r transceivers experience a failure, the spatial FEC codewords can correct the resulting bit errors and, as previously mentioned, prevent post-FEC errors from occurring. In embodiments, if a primary transceiver fails, a redundant transceiver may be activated to take its place. Although this swapping operation may cause a momentary disruption in data transmission if the transmitter and receiver sides are not perfectly synchronized, data integrity and continuous connectivity are maintained once the swap is complete.

In embodiments, any number of overhead bits (denoted as “OH” in FIG. 6b) may be added at any location within each frame (e.g., after the FAS portion) to manage communication between transmit and receive nodes. Such overhead bits enable the system to coordinate the swapping of transceivers. For example, they may be used to signal when a spare transceiver should start sending data or when the receiver should switch to a spare transceiver. In embodiments, suitable protocols may be used to ensure proper communication and coordination during this process.

In embodiments, overhead bits help ensure that the spare transmitter starts correctly sending identical data, effectively replacing the failed transceiver without losing data. Conversely, a spare receiver may immediately take over to replace the failed receiver and continue providing the necessary signals for FEC decoding to correct bit errors and ensure accurate recovery of the original data, thus making the swapping operation seamless.

As shown FIG. 6a, a FEC encoder or codeword generator circuit is provided that is configured to generate a forward error correction codeword having a plurality of bits, the plurality of bits including payload bits and check bits, as shown in FIGS. 6a and 6b. As shown in FIG. 6b, a first plurality of optical transmitters (see, for example, transmitters TX #1 to TX #N+1) is also provided, whereby each such optical transmitter (see also FIG. 5c) is configured to receive a corresponding one of a first plurality of electrical signals whereby each of the plurality of bits is associated with a corresponding one of the first plurality of optical transmitters, such that each of the first plurality of optical transmitters (see, for example, transmitters TX #1 to TX #N+1) provides a corresponding one of a first plurality of modulated optical signals (see also FIG. 5c). Moreover, a second plurality of optical transmitters (for example, TX #N+r+1 to TX #N+r+s) is provided for redundancy, such that one of the second plurality of optical transmitters being operable to provide a second modulated optical signal when a fault occurs in one of the first plurality of optical transmitters (TX #1 to TX #N+1), such that the second modulated optical signal carries one of the plurality of bits associated with said one of the plurality of optical transmitters including the fault. A first plurality of optical paths, each of which being coupled to a respective one of the first plurality of optical transmitters (see media connected to TX #1 and RX #1, for example, and additional media connecting respective RX and TX pairs: TX #2,RX #2 to TX #N to RX #N. Each medium may include a waveguide, for example, or an optical fiber. A second plurality of optical paths are provided, each of which being coupled between corresponding pairs of receivers selected from (Rx #N+r+1 to Rx #N+r+s) and transmitters selected from (Tx #N+r+1 to Tx #N+r+s), to provide redundancy. Moreover, a first plurality of optical receivers (RX #1 to Rx #N+r) is provided, each of which being coupled to a respective one of the first plurality of optical paths or media, and a second plurality of optical receivers (RX #N+r+1 to RX #N+r+s) is provided, each of which being coupled to a respective one of the second plurality of optical paths or media.

In operation, data or a series of bits is fed to an FEC encoder (FIG. 6a), which generates a codeword including payload bits and FEC check bits. The bits of the codeword are generated in parallel, and each such parallel bit of the codeword is provided to a corresponding one of transmitters TX by way of a respective switch SW1 to SWN+r. In response to a fault in a laser included in on of the optical transmitters, for example, TX #1, switch SW1 may be activated to direct the corresponding output codeword bit to one of the spare transmitters, such as TX #N+r+1. In a similar manner, other switches SW may be activated to direct bits output from the FEC encoder to corresponding spare transmitters. In the event no fault is detected in the transmitters, such as a laser fault, none of the switches is activated and each bit of the codeword is passed or provided in parallel to a corresponding transmitter TX.

FIG. 6c shows circuitry that receives outputs from optical receiver circuits RX #1 to RX #N+r, whereby each receiver corresponds to a respective bit of a codeword including payload bits and FEC check bits, as shown in FIG. 6c. In the event of a fault in one of the transmitters TX, however, one of the received bits will be output from one of the spare receivers RX #N+r+1 to RX #N+R+s. The output bit or corresponding electrical signal will be provided to one of switches SW1 to SWN+r, which, in turn, directs the bit to an FEC decoder circuit. Other received parallel bits of the codeword are supplied to the FEC decoder circuit, which decodes the codeword and outputs a copy of the data input to the encoder in FIG. 6a.

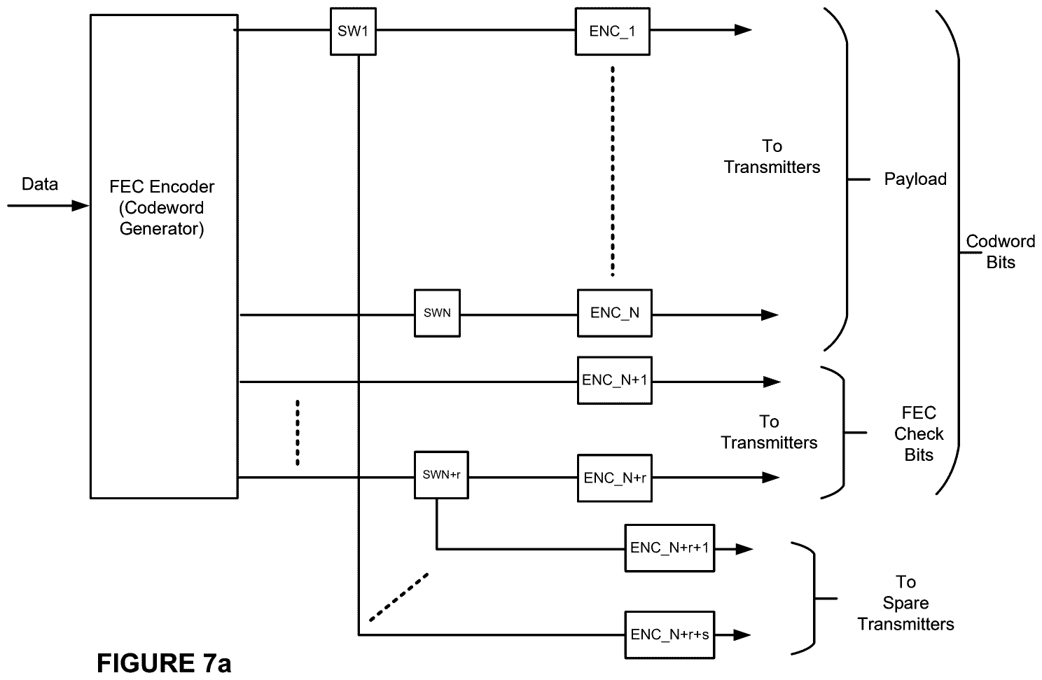

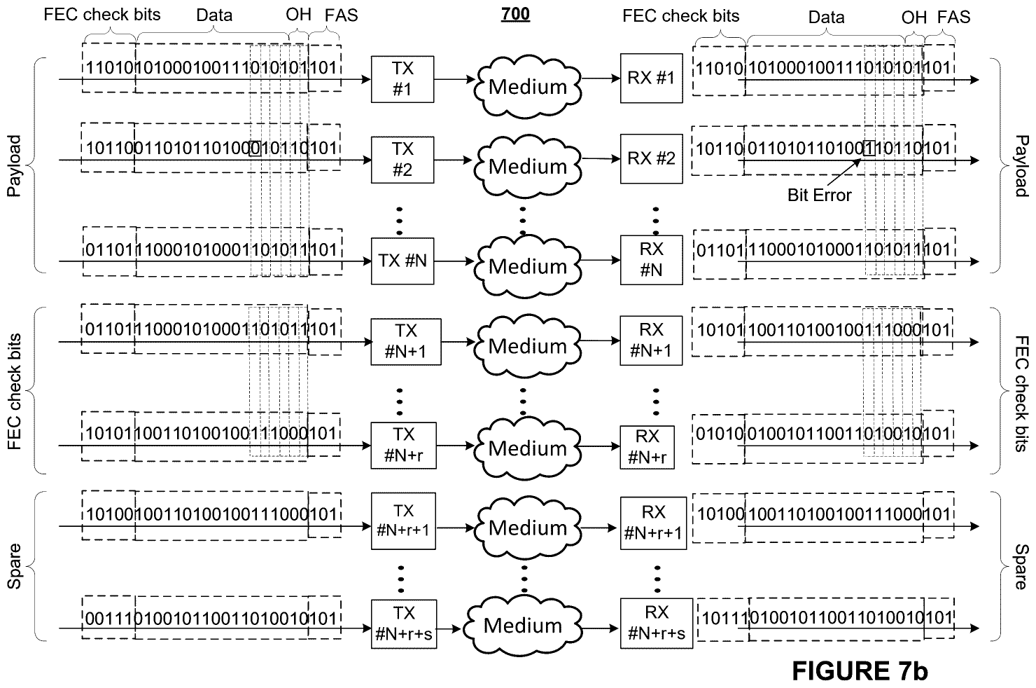

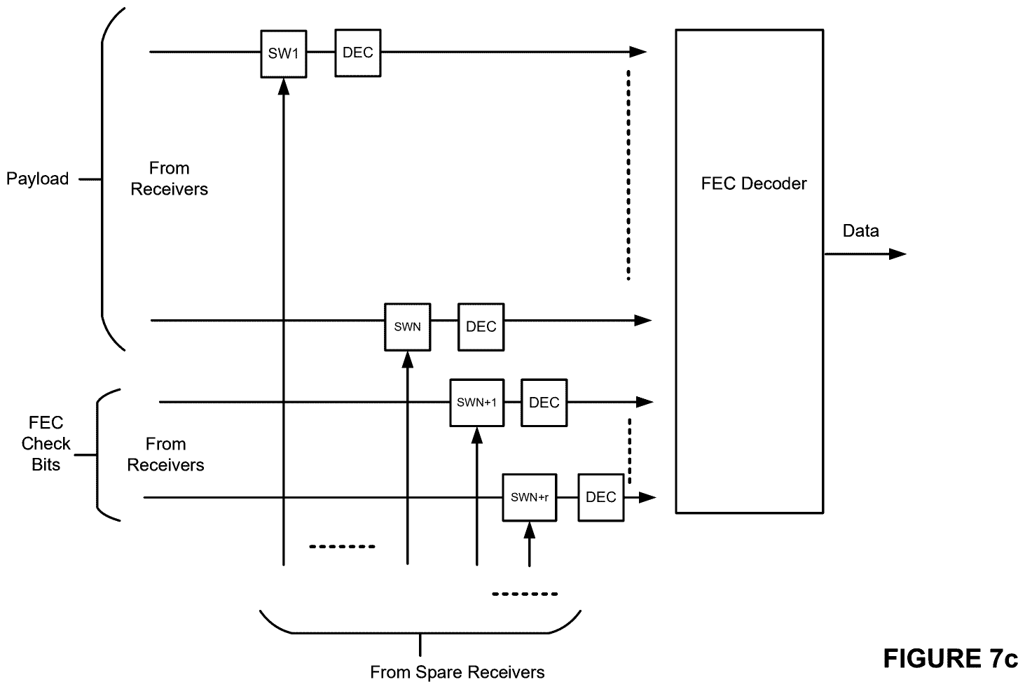

FIGS. 7a to 7c illustrate a encoder and decoder circuitry, as well as transmitters and receiver pairs and associated media or links in a communication system. Put another way, FIGs, 7a to 7c illustrate an exemplary digital communication system that utilizes temporal FEC, spatial FEC, and spare transceivers, according to various embodiments of the present disclosure. As previously mentioned, temporal FEC is effective for correcting common bit errors that arise due to imperfections in the transceiver hardware or transmission medium (e.g., signal degradation over distance, interference), where redundancy is added within the data stream over time. In contrast, spatial FEC ensures data integrity despite catastrophic transceiver failures by distributing redundancy across multiple transceivers to recover the lost information from the remaining operational transceivers to ensure that even if a transceiver fails, the data can still be accurately reconstructed. Therefore, for a comprehensive error correction approach, various embodiments, in addition to spatial FEC, incorporate traditional temporal FEC methods into the communication system to further enhance error correction efficiency. Advantageously, by using both spatial and temporal FEC in this manner, digital communication systems can efficiently correct a wider range of errors, thus enhancing overall reliability and robustness of the system.

It is understood that, in embodiments, spatial FECs and temporal FECs may use different FEC codes to address different types of errors. For example, a system may use one type of FEC code for spatial FEC and another type for temporal FEC. It is further understood that although examples herein are presented in the context of systematic code, this is not intended as a limitation on the scope of the present disclosure. As a person of skill in the art will appreciate, suitable FECs may equally comprise non-systematic codes, such as, for example, convolutional code.

In one example, the encoder circuitry shown in FIG. 7a is similar to that shown in FIG. 6a. In FIG. 7a, additional FEC encoder circuits ENC are provided at each switch output to provide additional temporal forward error correction encoder. In addition, the example shown in FIG. 7c is similar to that shown in FIG. 6c. In FIG. 7c, however, additional FEC decoder circuits are provided at the outputs of each switch SWN to provided additional temporal decoding.

The digital communication systems illustrated in FIGS. 5a, 5b, 6a-6c, and 7a to 7care not limited to the constructional detail shown therein or described in the accompanying text. As those skilled in the art will appreciate, a suitable communication system may comprise any number of additional or auxiliary components, such as multiplexers, buffers, etc., which may be combined in various configurations.

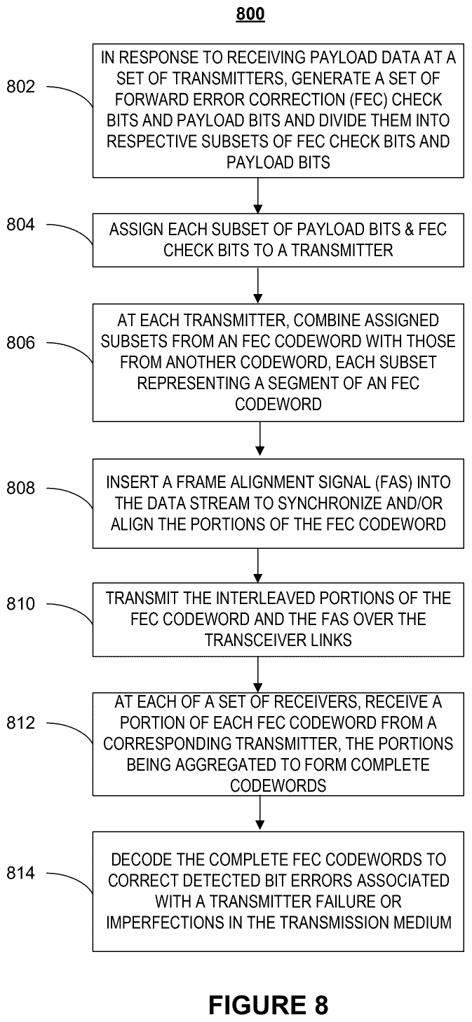

FIG. 8 is a flowchart illustrating a process for using spatial FEC according to various embodiments of the present disclosure. Process 800 may begin at step 802, when, in response to receiving payload data at a set of transmitters (e.g., from a processor), a set of FEC check bits and payload bits are generated and divided into respective subsets of FEC check bits and payload bits.

At step 804, each subset of payload bits and FEC check bits may be assigned to a transmitter.

At step 806, each transmitter may combine its assigned subset of payload bits and FEC check bits from one FEC codeword with its assigned subset of payload bits and FEC check bits from other FEC codewords. Each assigned subset of payload bits and FEC check bits represents a segment of an FEC codeword.

At step 808, a FAS is inserted into the data stream, e.g., at regular intervals, by each transmitter to ensure that the portions of the FEC codeword are properly synchronized and aligned.

At step 810, each transmitter transmits the interleaved portion of the FEC codeword and the FAS over a transceiver link.

At step 812, each of a set of receivers receives a portion of each FEC codeword from a corresponding transmitter. These received portions of FEC codewords are aggregated to form complete FEC codewords.

At step 814, the complete FEC codewords are decoded to correct any detected bit errors associated with a transmitter failure and/or imperfections in the transmission medium.

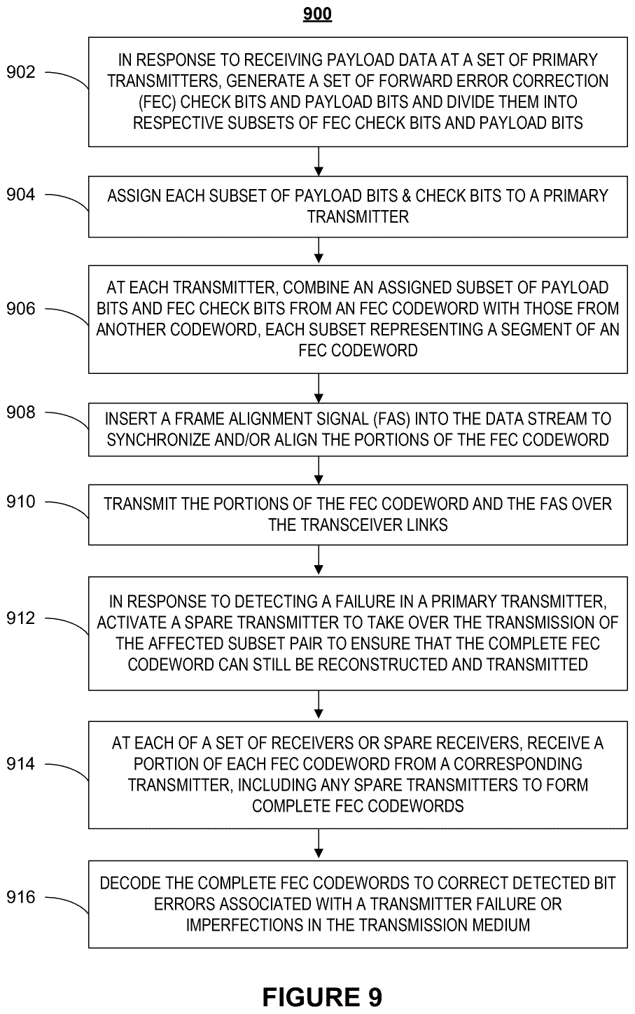

FIG. 9 is a flowchart illustrating a process for using spare transceivers with spatial FEC according to various embodiments of the present disclosure. Similar to the process illustrated in FIG. 8, process 900 may begin at step 902, when, in response to receiving payload data at a set of primary transmitters, a set of FEC check bits and payload bits are generated and divided into respective subsets of FEC check bits and payload bits.

At step 904, each subset of payload bits and FEC check bits is assigned to a primary transmitter.

At step 906, each primary transmitter may combine its assigned subset of payload bits and FEC check bits from one FEC codeword with its assigned subset of payload bits and FEC check bits from other FEC codewords. Each assigned subset of payload bits and FEC check bits represents a segment of an FEC codeword.

At step 908, a FAS is inserted into the data stream by each primary transmitter to ensure that the portions of the FEC codeword are properly synchronized and aligned.

At step 910, each primary transmitter transmits the portion of the FEC codeword and the FAS over a transceiver link.

At step 912, the transceiver links are monitored for any failures in the primary transmitters and, in response to detecting a failure, a spare transmitter is activated, to take over the transmission of the affected subset pair, such as to ensure that the complete FEC codeword can still be reconstructed and transmitted.

At step 914, each of a set of receivers, including any spare receivers, receives a portion of each FEC codeword from a corresponding transmitter, including any spare transmitters. These received portions of FEC codewords are aggregated to form complete FEC codewords.

At step 916, the complete FEC codewords are decoded to correct any detected bit errors associated with a transmitter failure and other imperfections in the transceiver hardware or transmission medium.

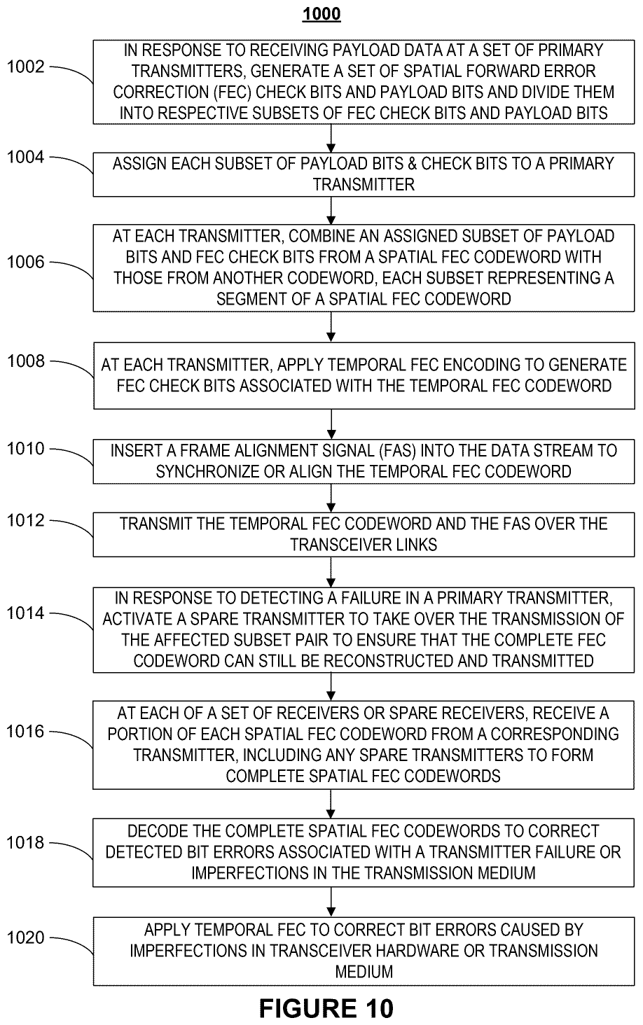

FIG. 10 is a flowchart illustrating a process for using spare transceivers with spatial FEC in conjunction with temporal FEC according to various embodiments of the present disclosure. Steps 1002 through 1006 of process 1000, where overhead bits may be added (e.g., at regular intervals) to the data stream to manage communication between transmit and receive nodes and to facilitate the activation of spare transmitters in case of failure, are similar to steps 902 through 906 in FIG. 9.

As depicted in FIG. 10, at step 1008, temporal FEC encoding may be applied to generate FEC check bits associated with the temporal FEC codeword. Steps 1010 through 1018 of process 1000 are similar to steps 908 through 916 in FIG. 9.

Finally, at step 1020, temporal FEC may be applied by each receiver to further correct bit errors caused by imperfections in the transceiver hardware or transmission medium.

It is understood that, in embodiments, the order of steps 1018 and 1020 of process 1000 may be altered such that decoding of the temporal FEC may commence before that of the spatial FEC codewords. It is further understood that the processes discussed with reference to FIG. 8 through FIG. 10 may comprise any number of additional or different steps, including each receiver deskewing and aligning the data from different transceiver links to correct timing differences between the links. Each receiver may use the FAS to synchronize with its corresponding transmitter to ensure correct interpretation and alignment of the data.

One skilled in the art will recognize that: (1) certain steps may optionally be performed; (2) steps may not be limited to the specific order set forth herein; (3) certain steps may be performed in different orders; and (4) certain steps may be done concurrently. One skilled in the art will further recognize no computing system or programming language is critical to the practice of the present disclosure and that a number of the elements described above may be physically and/or functionally separated into modules and/or sub-modules or combined.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. An apparatus, comprising:
a codeword generator circuit configured to generate a forward error correction codeword having a plurality of bits, the plurality of bits including payload bits and check bits;
a first plurality of optical transmitters, each of which being configured to receive a corresponding one of a first plurality of electrical signals whereby each of the plurality of bits is associated with a corresponding one of the first plurality of optical transmitters, such that each of the first plurality of optical transmitters provides a corresponding one of a first plurality of modulated optical signals; and
a second plurality of optical transmitters, one of the second plurality of optical transmitters being operable to provide a second modulated optical signal when a fault occurs in one of the first plurality of optical transmitters, such that the second modulated optical signal carries one of the plurality of bits associated with said one of the plurality of optical transmitters including the fault.

2. An apparatus in accordance with claim 1, wherein each of the plurality of optical transmitters includes a laser.

3. An apparatus in accordance with claim 1, wherein said one of the plurality of bits is included in a frame alignment signal.

4. An apparatus in accordance with claim 1, wherein said one of the plurality of bits is a data bit.

5. An apparatus in accordance with claim 1, wherein said one of the plurality of bits is an overhead bit.

6. An apparatus, comprising:
a codeword generator circuit configured to generate a forward error correction codeword having a plurality of bits, the plurality of bits including payload bits and check bits;
a first plurality of optical transmitters, each of which being configured to receive a corresponding one of a first plurality of electrical signals whereby each of the plurality of bits is associated with a corresponding one of the first plurality of optical transmitters, such that each of the first plurality of optical transmitters provides a corresponding one of a first plurality of modulated optical signals;
a second plurality of optical transmitters, one of the second plurality of optical transmitters being operable to provide a second modulated optical signal when a fault occurs in one of the first plurality of optical transmitters, such that the second modulated optical signal carries one of the plurality of bits associated with said one of the plurality of optical transmitters including the fault;
a first plurality of optical paths, each of which being coupled to a respective one of the first plurality of optical transmitters;
a second plurality of optical paths, each of which being coupled to a respective one of the second plurality of optical transmitters;
a first plurality of optical receivers, each of which being coupled to a respective one of the first plurality of optical paths; and
a second plurality of optical receivers, each of which being coupled to a respective one of the second plurality of optical paths.

7. An apparatus in accordance with claim 6, wherein each of the plurality of optical transmitters includes a laser.

8. An apparatus in accordance with claim 6, wherein said one of the plurality of bits is included in a frame alignment signal.

9. An apparatus in accordance with claim 6, wherein said one of the plurality of bits is a data bit.

10. An apparatus in accordance with claim 6, wherein said one of the plurality of bits is an overhead bit.

11. An apparatus in accordance with claim 6, wherein each of the first plurality of optical paths and each of the second plurality of optical paths includes a waveguide.

12. An apparatus in accordance with claim 6, further including a FEC decoder circuit coupled to each of the first plurality of optical receivers and each of the second plurality of optical receivers.

13. An apparatus in accordance with claim 12, wherein data is provided to the first codeword generating circuit, said data being out from the FEC decoder circuit.

14. An apparatus, comprising:
a first codeword generator circuit configured to successively generate each of a plurality of first forward error correction (FEC) codewords,
a plurality of second codeword generator circuits, wherein each bit of each of the first FEC codewords being supplied in parallel to a corresponding one of the plurality of second codeword generator circuits, each of the second codeword generator circuits supplying a corresponding one of a plurality of second FEC codewords, each of the plurality of second FEC codewords being associated with a corresponding one of a plurality of electrical signals;
a plurality of optical transmitters, each of which receiving a corresponding one of the plurality of electrical signals, such that each of the first plurality of optical transmitters provides a corresponding one of a plurality of modulated optical signals.

15. An apparatus in accordance with claim 14, wherein each of the plurality of optical transmitters includes a laser.

16. An apparatus in accordance with claim 14, wherein each of the plurality of second FEC codewords includes a frame alignment signal.

17. An apparatus in accordance with claim 14, wherein each of the plurality of second FEC codewords includes data.

18. An apparatus in accordance with claim 14, wherein each of the plurality of second FEC codewords includes overhead bits.

19. An apparatus in accordance with claim 14, wherein each of the first plurality of optical paths and each of the second plurality of optical paths includes a waveguide.

20. An apparatus in accordance with claim 19, further including an FEC decoder circuit coupled to each of the first plurality of optical receivers and each of the second plurality of optical receivers.
